(19) United States
(12) Patent Application Publication
(10) Pub. No.: US 2023/0276514 A1
(43) Pub. Date: Aug. 31, 2023

(54) RELAY ADVERTISEMENT FOR SIDELINK OPERATION

(71) Applicant: Lenovo (Singapore) Pte. Ltd., New Tech Park (SG)

(72) Inventors: Prateek Basu Mallick, Dreieich (DE); Karthikeyan Ganesan, Kronberg im Taunus (DE); Joachim Loehr, Wiesbaden (DE); Ravi Kuchibhotla, Chicago, IL (US)

(21) Appl. No.: 18/019,466

(22) PCT Filed: Aug. 5, 2021
(86) PCT No.: PCT/IB2021/057227

§ 371 Date: Feb. 2, 2023

Related U.S. Application Data
(60) Provisional application No. 63/061,715, filed on Aug. 5, 2020.
(60) Provisional application No. 63/061,725, filed on Aug. 5, 2020.
(60) Provisional application No. 63/061,731, filed on Aug. 5, 2020.
(60) Provisional application No. 63/061,734, filed on Aug. 5, 2020.
(60) Provisional application No. 63/061,746, filed on Aug. 5, 2020.

(51) Int. Cl. H04W 76/14; H04W 8/00

(52) U.S. Cl. CPC H04W 76/14; H04W 8/005; H04W 88/04

(57) ABSTRACT

Apparatuses, methods, and systems are disclosed for relay advertisement for sidelink operation. One apparatus includes a processor and a transceiver that receives a relay advertisement from a SL Relay UE supporting sidelink operation, where the relay advertisement contains at least one relay attribute. The processor determines that relay via the SL Relay UE is needed using the at least one relay attribute. The transceiver sends a relay connection request to the SL Relay UE and receives a relay connection confirmation from the SL Relay UE. Via the transceiver, the processor performs sidelink communication with a remote receiver device via the SL Relay UE.

### CROSS-REFERENCE TO RELATED APPLICATIONS

This application claims priority to U.S. Patent Application Ser. No. 63/061,715 entitled “APPARATUSES, METHODS, AND SYSTEMS FOR A SIDELINK RESOURCE ALLOCATION PROCEDURE FOR SIDELINK RELAY COMMUNICATION” and filed on Aug. 5, 2020 for Joachim Loehr, Prateek Basu Mallick, Karthikeyan Ganesan, and Ravi Kuchibhotla; to U.S. Patent Application Ser. No. 63/061,725 entitled “MECHANISMS FOR IMPROVED COMMUNICATIONS USING RELAY OVER SIDELINK RADIO INTERFACE” and filed on Aug. 5, 2020 for Prateek Basu Mallick, Joachim Loehr, Ravi Kuchibhotla, and Karthikeyan Ganesan; to U.S. Patent Application Ser. No. 63/061,731 entitled “SELECTION OF RELAY DEVICE IN SIDELINK COMMUNICATIONS” and filed on Aug. 5, 2020 for Prateek Basu Mallick, Karthikeyan Ganesan, Joachim Loehr, and Ravi Kuchibhotla; to U.S. Patent Application Ser. No. 63/061,734 entitled “MECHANISMS TO SUPPORT TRANSMISSION FEEDBACK OVER SIDELINK RELAY” and filed on Aug. 5, 2020 for Prateek Basu Mallick, Joachim Loehr, Karthikeyan Ganesan, and Ravi Kuchibhotla; and to U.S. Patent Application Ser. No. 63/061,746 entitled “APPARATUSES, METHODS, AND SYSTEMS FOR DETERMINING THE BEHAVIOUR OF A SIDELINK RELAY UE USING MCR AND ZONE” and filed on Aug. 5, 2020 for Karthikeyan Ganesan, Prateek Basu Mallick, Joachim Loehr, and Ravi Kuchibhotla, all of which are incorporated herein by reference in their entirety.

### FIELD

The subject matter disclosed herein relates generally to wireless communications and more particularly relates to relay advertisement for selecting a relay device in sidelink communication.

### BACKGROUND

A Sidelink (“SL”) relay is a potential means to increase coverage using one or multiple hops. For UE-to-network coverage extension, Uu coverage reachability is necessary for UEs to reach a server in a Packet Data Network (“PDN”) or a counterpart User Equipment (“UE”) out of proximity area. For UE-to-UE coverage extension, currently proximity reachability is limited to single-hop sidelink link, either via Evolved Universal Terrestrial Radio Access (“EUTRA”)-based or NR-based sidelink technology.

### BRIEF SUMMARY

Disclosed are procedures for relay advertisement for sidelink operation. Said procedures may be implemented by apparatus, systems, methods, or computer program products.

One method of a Transmitting Remote User Equipment (“Tx Remote UE”) for relay advertisement for sidelink operation includes receiving a relay advertisement from a relay

User Equipment (“UE”) device supporting sidelink (“SL”) operation, where the relay advertisement contains at least one relay attribute, and determining that relay via the SL Relay UE is needed using the at least one relay attribute. The method includes sending a relay connection request to the SL Relay UE, receiving a relay connection confirmation from the SL Relay UE, and performing SL communication with a remote receiver device via the SL Relay UE.

One method of a Sidelink Relay User Equipment (“SL Relay UE”) for relay advertisement for sidelink operation includes transmitting a relay advertisement from a SL Relay UE supporting SL operation and receiving a relay connection request from a remote transmitter device, where the relay advertisement contains at least one relay attribute and where the remote transmitter device selects the SL Relay UE using the at least one relay attribute. The method includes transmitting a relay connection confirmation to the remote transmitter device and relaying SL communication between the remote transmitter device and a remote receiver device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for relay advertisement for sidelink operation;

FIG. 2A is a block diagram illustrating one embodiment of a relay arrangement for sending a Transport Block (“TB”) via unicast transmission;

FIG. 2B is a block diagram illustrating one embodiment of a Sidelink (e.g., PC5) protocol stack;

FIG. 3 is a block diagram illustrating one embodiment of a procedure to select a relay device;

FIG. 4 is a block diagram illustrating one embodiment of a 5G New Radio (“NR”) protocol stack;

FIG. 5 is a block diagram illustrating one embodiment of a user equipment apparatus that may be used for relay advertisement for sidelink operation;

FIG. 6 is a block diagram illustrating one embodiment of a network equipment apparatus that may be used for relay advertisement for sidelink operation;

FIG. 7 is a block diagram illustrating one embodiment of a first method for relay advertisement for sidelink operation; and

FIG. 8 is a block diagram illustrating one embodiment of a second method for relay advertisement for sidelink operation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mechanisms for selecting a relay device for sidelink operation from a relay advertisement. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As described above, two types of relays are considered herein:
1) UE-to-network relay (also referred to as “N-relay”): Uu coverage reachability is necessary for UEs to reach server in Packet Data Network (“PDN”) or counterpart UE out of proximity area. However, N-relay solution previously defined in 3GPP Rel-13 is limited to EUTRA-based technology, and thus cannot be applied to NR-based system, for both Next-Generation (i.e., 5G) Radio Access Network (“NG-RAN”) and NR-based sidelink communication.
2) UE-to-UE relay (also referred to as “UE-relay”): Currently, proximity reachability is limited to single-hop sidelink link, either via EUTRA-based or NR-based sidelink technology. However, that is not sufficient in the scenario where there is no Uu coverage (i.e., the UE is outside of RAN coverage), considering the limited single-hop sidelink coverage.

For both Sidelink (“SL”) relay types, a SL remote UE needs to discover and select a Relay for transmissions to a SL Remote. Described herein are mechanisms defining criteria used to select a SL Relay UE. Described herein are mechanisms defining when a transmitter (“Tx”) SL remote UE (also referred to as “Tx remote UE”) starts sending data through a selected SL Relay UE and when the Tx SL remote UE stops sending data through the selected SL Relay UE.

Multi Relay for NR sidelink is a new study. In previous systems like Evolved Universal Terrestrial Radio Access (“EUTRA”), the related concept of Hybrid Automatic Repeat Request (“HARQ”) feedback was not used and therefore there is not a direct conventional solution available using relay scenarios for increasing reliability and/or coverage.

This disclosure describes many new attributes that may be advertised by a relay and other criteria, which help a Tx remote UE (also referred to herein as “UE1”)to decide if it should select a given relay. In addition, new triggers are defined, when a remote UE may start relaying data via a relay UE to another remote UE and also when remote UE may stop relaying data via the relay UE. In addition, two different Tx-Remote-UE behaviors are defined upon relay (re)selections when a particular TB may still be in transmission in the previous link (Uu, direct link or using previous relay).

There are no previous solutions in NR system wherein a Relay is used in sidelink to increase reliability. There are no previous solutions in 3GPP when the sidelink communication using relays utilizes sidelink HARQ feedback-based retransmissions. A SL relay UE (also referred to herein as “UE2”) may be used to reach a Rx remote UE (also referred to herein as “UE3”); however, the UE behaviors of the remote UE in selection of a relay UE given the features of SL HARQ feedback, MCR, 3 cast-types are not yet available. Because a relay is used to reach a remote receiver UE that may otherwise may not be in communication range of the remote transmitter, the solutions revealed here not only increase reliability of transmission but increase coverage as well.

In one embodiment, several trigger points are revealed. A remote UE1 starts looking for a relay using the following triggers:

For UC (Unicast) transmission by the UE1 to the UE3
After ‘n1’ unsuccessful attempts to reach the unicast (“UC”) destination (i.e., the UE3) directly.
When the UC destination (i.e., the UE3) is reachable but the link conditions are not satisfactory.

For Groupcast (“GC”) direct transmission by UE1 to UE3 (and other receiver UEs)
When using SL HARQ feedback Option 2 and ‘n2’ acknowledgement(s) for are missing (not received at UE1)
When using SL HARQ feedback Option 2 and NACK is received ‘n3’ times
When using SL HARQ feedback Option 2 and the sum of received NACKs and missing Feedbacks (i.e., DTX from receiver UEs) exceeds ‘n4’
When using SL HARQ feedback option 1 and NACK is received ‘n5’ times
When the UE1 does not have access to its location

According to SL HARQ feedback Option 1 (i.e., a NACK-only indication sent using a common feedback resource), all receiver(s) that failed to successfully decode the received SL Data packet will send a HARQ NACK on the resource common to all the receivers. The HARQ NACK feedback is System Frame Number (“SFN”) combined over the air.

According to SL HARQ feedback Option 2 (i.e., a Rx UE-specific ACK indication or NACK indication that is sent using dedicated feedback resources), every receiver that received Physical Sidelink Control Channel (“PSCCH”) (e.g., containing Sidelink Control Information (“SCI”)) and attempted to decode corresponding Physical Sidelink Shared Channel (“PSSCH”) (e.g., containing SL Data) is to feedback HARQ-ACK in the corresponding resources depending on if they were successful or not in decoding the Data packet.

As used herein, “HARQ-ACK” may represent collectively the Positive Acknowledge (“ACK”) indication, the Negative Acknowledge (“NACK”) indication, and the

Discontinuous Transmission (“DTX”) indication. Signaling ACK means that a Transport Block (“TB,” also referred to as a data packet) is correctly received. Signaling NACK (or NAK) means a TB is erroneously received (e.g., received but unsuccessfully decoded), while signaling DTX means that no TB was detected.

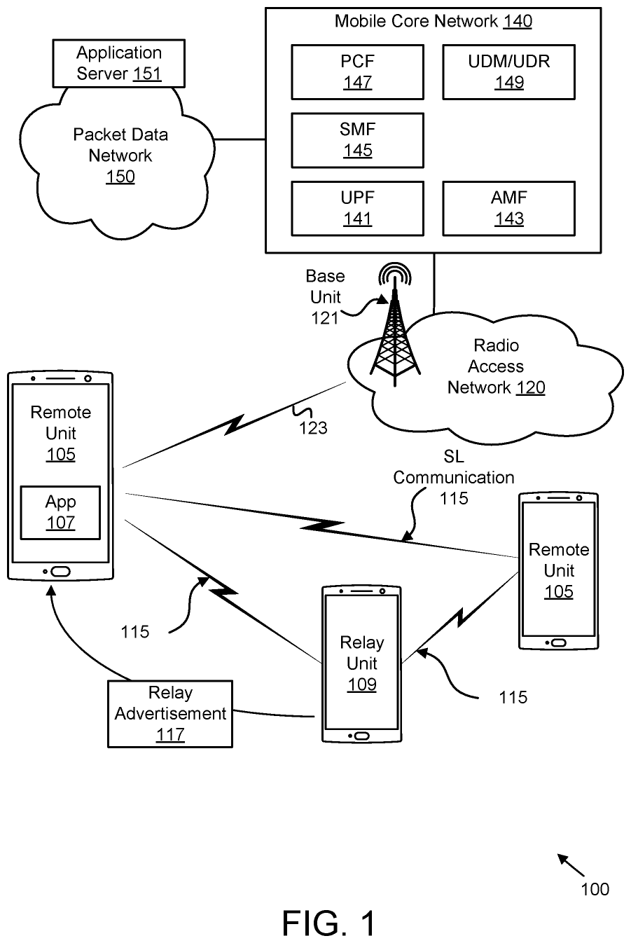

FIG. 1 depicts a wireless communication system 100 for relay advertisement for sidelink operation, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”)

Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM″”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for relay advertisement for sidelink operation apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the below described solutions/methods are also equally applicable to other mobile communication systems relay advertisement for sidelink operation.

In various embodiments, the remote units 105 may communicate directly with each other (e.g., device-to-device communication) using SL communication links 115. Here, SL transmissions may occur on SL resources. The remote units 105 implement SL HARQ processes for at least some data transferred over SL communication signals 115, as discussed in greater detail below.

In various embodiments, the transmitting remote unit 105 (i.e., source UE) may not be in range to transmit directly to the receiving remote unit 105 (i.e., destination UE). In such embodiments, the transmitting remote unit 105 may use one or more relay units 109 to reach the receiving remote unit. A relay unit 109 may be one embodiment of the remote unit 105, i.e., a UE configured to relay transmissions over SL communication links 115. The relay unit(s) 109 may relay both data packets and HARQ feedback, as discussed in greater detail below.

In NR V2X communication Rel. 16, SL HARQ feedback is used for groupcast and unicast communication to improve spectral efficiency. When SL HARQ feedback is enabled for unicast, in the case of non-Code Block Group (“CBG”) operation the receiver UE (“Rx UE,” i.e., receiving remote unit 105) generates HARQ-ACK if it successfully decodes the corresponding TB. The Rx UE generates HARQ-NACK if it does not successfully decode the corresponding TB after decoding the associated PSCCH targeted to the Rx UE.

For selection of a relay unit 109, a remote unit 105 may receive a relay advertisement 117 from a relay unit 109. Many attributes may be advertised by the relay unit 109, which assists the remote unit 105's decision of whether it should select a given relay unit 109.

Described herein are criteria used by a remote unit 105 to decide if it should select a given relay. Described herein are criteria used by a remote unit 105 to decide when to start relaying data via a relay unit 109 to another remote unit 105. Described herein are criteria used by a remote unit 105 to decide when to stop relaying data via the selected relay unit 109.

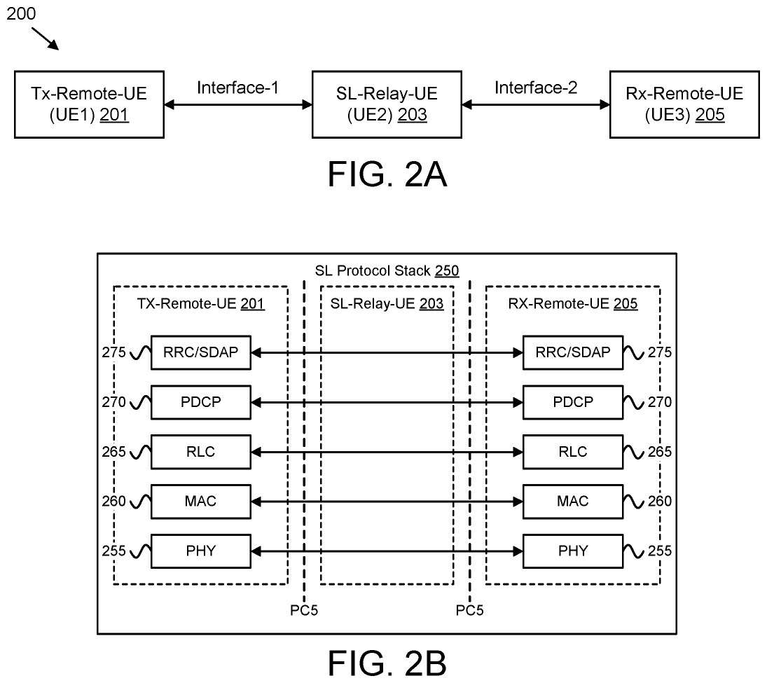

FIG. 2A is a block diagram illustrating one embodiment of a relay arrangement 200 for sending a TB via unicast transmission, according to the case of simple transmission referred to as “Case 1” (e.g., unicast on a sidelink interface). The arrangement 200 involves a Tx-Remote-UE (i.e., UE1) 201 which is the UE that has some application data to be sent to another Remote UE, shown as Rx-Remote-UE (i.e., UE3) 205, via a SL-Relay-UE (i.e., UE2) 203. At a different point in time, the UE3 205 may have data to send to the UE1 201 via the UE2 203 and, in this context, the UE3 205 would take the role of a transmitter UE. There the terms and roles shown in FIG. 2A, are with respect to a particular data packet (i.e., TB) only.

As depicted in FIG. 2A, the UE1 201 transmits a TB over Interface-1 to the UE2 203. The UE2 203 then transmits the TB to UE3 205 over a second sidelink interface (depicted as “Interface-2”). Here, the Interface-2 could be Unicast (“UC”) or Groupcast (“GC”), as indicated by UE1 201 to UE2 203. Alternatively, the Interface-2 could be Broadcast (“BC”), as indicated by UE1 201 to UE2 203. In FIG. 2A, only one UE3 205 is shown, but it is representative of one of multiple receivers for the GC or BC case.

FIG. 2A shows one example of a relay according to the first solution. In some cases, more than one SL Relay UE is available for use, e.g., a first SL Relay UE, a second SL Relay UE, etc. As such, “UE2” is a generalized representation of either or both of these. For groupcast and broadcast communication, the Rx-Remote-UE (UE3) 205 is a representation of all Rx-Remote-UEs. Note that in further embodiments, a Rx-Remote-UE 205 may act as a SL Relay UE to another destination UE (i.e., UE4), not shown in the FIG. 2A.

In other embodiments, the SL-Relay-UE 203 is a representation of multiple SL Relay UEs operating in parallel, wherein the Tx-Remote-UE (i.e., UE1) 201 may transmit the TB to the multiple SL Relay UEs on Interface-1 using groupcast or multiple unicast links. Alternatively, the Tx-Remote-UE (i.e., UE1) 201 may transmit the TB to the multiple SL Relay UEs on Interface-1 using broadcast.

Generally, a RAN node will set some criteria and a candidate relay UE will check if it fulfils them; when yes, it may announce itself to be a relay UE. To a remote UE, there may be more than one Relays visible. As used herein, visibility means that the measurement quality (i.e., Reference Signal Received Power (“RSRP”) and/or Reference Signal Received Quality (“RSRQ”)) of a Relay UE's reference signal(s) at the remote UE are above a certain threshold. A relevant question is how a remote UE would select a certain relay, i.e., based on which criteria apart from a radio threshold.

FIG. 2B depicts a PC5 protocol stack 250, according to embodiments of the disclosure. While FIG. 2B shows the TX-Remote-UE 201, the SL-Relay-UE 203, and the RX-Remote-UE 205, these are representative of a set of UEs communicating peer-to-peer via PC5 and other embodiments may involve different UEs. As depicted, the PC5 protocol stack includes a physical (“PHY”) layer 755, a Media Access Control (“MAC”) sublayer 760, a Radio Link Control (“RLC”) sublayer 765, a Packet Data Convergence Protocol (“PDCP”) sublayer 770, and Radio Resource Control (“RRC”) and Service Data Adaptation Protocol (“SDAP”) layers (depicted as combined element “RRC/SDAP” 775), for the control plane and user plane, respectively.

The AS protocol stack for the control plane in the PC5 interface consists of at least RRC, PDCP, RLC and MAC sublayers, and the physical layer. The AS protocol stack for the user plane in the PC5 interface consists of at least SDAP, PDCP, RLC and MAC sublayers, and the physical layer. The L2 is split into the SDAP, PDCP, RLC and MAC sublayers. The L3 includes the RRC sublayer and the NAS layer for the control plane and includes, e.g., an IP layer for the user plane. L1 and L2 are referred to as “lower layers”, while L3 and above (e.g., transport layer, V2X layer, application layer) are referred to as “higher layers” or “upper layers.”

In some embodiments, the SL-Relay-UE 203 acts as a L3 relay (also referred to as an IP relay). Here, communication between the Tx-Remote-UE 201 (i.e., source UE) and the Rx-Remote-UE 205 (i.e., target UE) via L3 relay goes through two combined PC5 links, i.e., a first PC5 link (corresponding to Interface-1) between the Tx-Remote-UE 201 and the SL-Relay-UE 203 and a second PC5 link (corresponding to Interface-2) between the SL-Relay-UE 203 and the Rx-Remote-UE 205. In such embodiments, the protocol stack of the SL-Relay-UE 203 may include SDAP, RRC, PDCP, RLC, MAC and PHY layers which interact with corresponding layers at the Tx-Remote-UE 201 via the Interface-1, and which also interact with corresponding layers at the Rx-Remote-UE 205 via the Interface-2.

In some embodiments, the SL-Relay-UE 203 acts as a L2 relay. In certain embodiments, the SL-Relay-UE 203 acting as a L2 relay performs relay function below the PDCP layer 770, such that the SL-Relay-UE 203 does not perform PDCP, RRC and SDAP functions for the SL communication. In such embodiments, the protocol stack of the SL-Relay-UE 203 may include RLC layer 765, MAC layer 760 and PHY layer 755 entities which interact with corresponding layers at the Tx-Remote-UE 201 via the Interface-1, and which interact with corresponding layers at the Rx-Remote-UE 205 via the Interface-2. However, for the PDCP layer 770, the RRC and SDAP layers 775, the link endpoints are between the Tx-Remote-UE 201 and the Rx-Remote-UE 205.

In some embodiments, the SL-Relay-UE 203 acts as a L1 relay (also referred to as an Amplify and Forward relay) with HARQ functionality. In certain embodiments, the protocol stack of the SL-Relay-UE 203 may have PHY layer 755 and a HARQ entity (i.e., of the MAC layer 760) which interact with corresponding layers at the Tx-Remote-UE 201 via the Interface-1, and which interact with corresponding layers at the Rx-Remote-UE 205 via the Interface-2. However, for the remaining layers, the link endpoints are between the Tx-Remote-UE 201 and the Rx-Remote-UE 205.

Note that the above relay descriptions are exemplary, and the SL-Relay-UE 203 is not limited to the above-described relay implementations. Thus, the SL-Relay-UE 203 may implement different protocol stacks and/or link endpoints than those described above, according to the below described solutions.

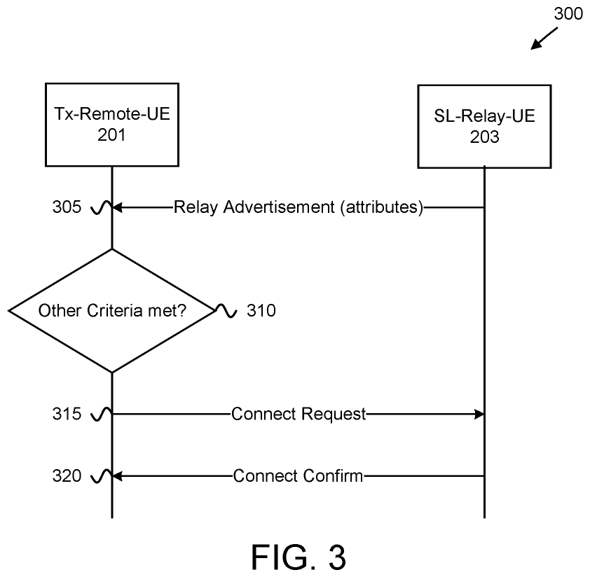

FIG. 3 is a block diagram illustrating one embodiment of a procedure 300 for relay advertisement, according to embodiments of the disclosure. The procedure 300 involves a Remote UE (here, the Tx-Remote-UE 201) and a Relay UE (here, the SL-Relay-UE 203). As depicted, the SL-Relay-UE 203 sends a Relay Advertisement 305 (containing attributes) to the Tx-Remote-UE 201.

The following are some examples of attributes that may be advertised by a relay:
A) Group membership: Relay UE (i.e., SL-Relay-UE 203) and remote UE (i.e., Tx-Remote-UE 201) are members of at least one common group, i.e., these are members of one certain common L2 Group Destination ID. The relay advertises all its L2 Group Destination ID(s);
B) Relay UE (i.e., SL-Relay-UE 203) advertises all cast type that it supports for relaying purpose;
C) Relay UE (i.e., SL-Relay-UE 203) advertises one or both of HARQ Feedback support and support for Blind Retransmissions;
D) Relay UE (i.e., SL-Relay-UE 203) advertises its location availability (relay knows its location or not);
E) Relay UE (i.e., SL-Relay-UE 203) advertises its Minimum Communication Range (“MCR”) support capability, i.e., if it supports to seek and monitor feedback and retransmit data to receiver Remote UEs (i.e., Rx-Remote-UE 205) within the MCR;
F) PQI: due to involvement of relay, the latency will certainly increase—so, not all PQIs may be served using any relay. Further, the capabilities at physical layer, FR2, etc., may vary from relay-to-relay. Therefore, a Relay UE may broadcast PQIs or PQI ranges that it supports for relaying. This may be achieved in several ways including a BITMAP where every bit of the bitmap corresponds to a specific PQI or to a specified range of PQIs;
G) Cell-Id (for N-relay), i.e., ECGI of the serving cell of the relay. A Remote UE may choose a Relay UE of its own serving cell or of a specific cell; and
H) Service type (PS, V2X, commercial): A Public-Safety (“PS”) Remote UE may only select a PS Relay UE, as an example.

According to embodiments of a first solution, a Remote UE (i.e., the Tx-Remote-UE 201) would choose (i.e., select and/or re-select) a Relay UE that advertises one or more attributes of interest.

Returning to FIG. 3, the Tx-Remote-UE 201 additionally determines if certain other criteria are met (see block 310). Other criteria that may be advertised by a Relay UE (i.e., the SL-Relay-UE 203) include, but are not limited to:
A) Radio criterion (e.g., measured RSRP of the SL-Relay-UE 203's reference signal(s) like Demodulation Reference signal (“DMRS”), Channel State Information Reference Signal (“CSI-RS”) or Sounding Reference Signal (“SRS”) with or without filtering is above a (pre)configured threshold);
B) CSI Reporting may play a role in Relay (re)selection L3 filtered value feedback; for higher reliability using CSI reporting could lead to selection of a Relay UE that has better radio/higher usable bandwidth (“BW”);
C) Interface-2 (e.g., as shown in FIG. 2) quality drives the (re)selection of Interface-1; and
D) Geographical distance between SL-Relay-UE 203 and the Tx-Remote-UE 201 when the radio criterion is met; some Tx-Remote-UEs 201 may prefer relay farther off in expectation that such a relay is close to one or more of the Rx-Remote-UEs 205.

Returning to FIG. 3, upon choosing a Relay UE (i.e., the SL-Relay-UE 203), the Tx-Remote-UE 201 sends a Connect Request message 315 to the SL-Relay-UE 203. If accepted, the SL-Relay-UE 203 replies by sending a Connect Confirm message 320 to the Tx-Remote-UE 201.

According to embodiments of a second solution, several trigger points are disclosed concerning when a remote UE1 (i.e., the Tx-Remote-UE 201) starts looking for a relay UE (i.e., the SL-Relay-UE 203) using the following triggers:

For UC (Unicast) transmission by Tx-Remote-UE 201 to Rx-Remote-UE 205, the Tx-Remote-UE 201 may use one or more of the following triggers:
Trigger A) after ‘n1’ unsuccessful attempts to reach the UC destination (i.e., UE3) directly. Here “unsuccessful attempts” implies that Tx-Remote-UE 201 does not successfully receive any of the responses/transmission/HARQ feedback from the Rx-Remote-UE (UE3) 205 for any of the ‘n1’ attempts made by Tx-Remote-UE 201. “Direct” means without using any relay or intermediate device. The said transmission may be physical signals, or higher layer data like MAC or RRC signaling or application data.
Trigger B) When the UC destination (i.e., UE3) is reachable but the link conditions are not satisfactory, e.g.,
HARQ operating point is higher than a threshold (e.g., consistently requires 2 retransmissions or more over a certain period).
Radio condition, i.e., measured RSRP and/or RSRQ of Rx-Remote-UE 205's reference signal(s) are worse than a threshold.
Radio Link Failure (“RLF”) has triggered or is about to trigger, i.e., Radio Link Monitoring has indicated one or more out-of-Sync indications to upper layer or a certain number of HARQ failures (DTX or NACK) has been received by Tx-Remote-UE 201.
Channel State Information (“CSI”) reporting indicates minimal schedulable BW.

For GC (Groupcast) direct transmission by Tx-Remote-UE 201 to Rx-Remote-UE 205 (and other receiver UEs), the Tx-Remote-UE 201 may use one or more of the following triggers:
Trigger A) When ‘n2’ acknowledgement(s) for SL HARQ feedback Option 2 are missing (not received at Tx-Remote-UE 201).
Trigger B) When receiving ‘n3’ NACKs for SL HARQ feedback Option 2.
Trigger C) When the sum of received NACKs for SL HARQ feedback Option 2 and missing Feedbacks (DTX from receiver UEs) exceeds ‘n4’.
Trigger D) When using SL HARQ feedback Option 1, NACK is received ‘n5’ times.
Trigger E) When the Tx-Remote-UE 201 does not have access to its location.

For GC or BC (Groupcast or Broadcast) transmission by Tx-Remote-UE 201 to Rx-Remote-UE 205 (and other receiver UEs), the Tx-Remote-UE 201 may use one or more of the following triggers:
Trigger A) Battery issue at Tx-Remote-UE 201: For example, VRU devices (pedestrians) may want to reduce its power consumption; or, when remaining battery in a UE/device is lower than certain percentage threshold (like 15% remaining battery).
Trigger B) Resource issues at Tx-Remote-UE 201, e.g., channel congestion/high CBR, and/or the Tx-Remote-UE 201 is out-of-coverage and therefore Mode 1 (i.e., network-scheduled operation mode) is not possible. In these cases, it is more efficient to transmit the TB successfully just to the Relay UE (i.e., SL-Relay-UE 203) which is in favorable radio condition.
Trigger C) When a relay is available/selected already due to another UC/GC.

The above counters n1, n2, n3, etc. may be for the same or different/subsequent

TB transmission; contiguous or otherwise; time bound or not. The thresholds and counters like n1, n2, n3 are (pre)configured or specified. For Groupcast, the total member UE information and MCR is signaled by the Tx-Remote-UE 201 to the SL-Relay-UE 203.

According to embodiments of a third solution, for a UC/GC/BC, a Tx-Remote-UE 201 may start using a Relay UE (i.e., the SL-Relay-UE 203) whenever a trigger described previously is fulfilled or when a Relay reselection occurs. At this point in time, some TBs may have been successfully transmitted and/or, a particular TB may still be in transmission.

In this case, the Tx-Remote-UE 201 may either first finish the transmission of the

TB already in transmission (successfully or not) or, in another implementation, may give-up immediately the transmission of the TB already in transmission. In one implementation of this embodiment, the “next” TB not yet attempted for transmission, is the first TB to be transmitted via the SL-Relay-UE 203. In another implementation, the last-TB that was unsuccessfully attempted for transmission by the Tx-Remote-UE 201 is the first TB to be transmitted via the SL-Relay-UE 203.

According to embodiments a fourth solution, the Tx-Remote-UE 201 determines when it may stop using a Relay UE (i.e., the SL-Relay-UE 203). This may be done when one or more of the following conditions are fulfilled:
A) When no relay is anymore available for relaying to the Rx-Remote-UE 205. This may happen when the relay the connection to SL-Relay-UE 203 is weak, or has been lost beyond recovery like in RLF (e.g., due to relative mobility) and no other relay towards the Rx-Remote-UE 205 is selected based on the attributes and other/radio conditions described previously.
B) When the Rx-Remote-UE 205 is directly reached from Tx-Remote-UE 201. Towards this end, the Tx-Remote-UE 201 may need to, from time to time, send transmissions directly to the Rx-Remote-UE 205 and see if the Rx-Remote-UE 205 is able to receive them and respond (with HARQ feedback). When this works well a certain number of times, the Tx-Remote-UE 201 may assume that the Rx-Remote-UE 205 can be reached directly and therefore it may stop using the SL Relay UE 203 towards the Rx-Remote-UE 205.
C) When the radio quality, e.g., measured RSRP of the SL-Relay-UE 203's reference signal(s) transmitted by one of them and measured by the other is above a (pre)configured threshold.
D) Upper layers terminate PC5 RRC Connection and/or PC5-S link between the Tx-Remote-UE 201 and the Rx-Remote-UE 205.
E) No more data available for the Rx-Remote-UE 205.

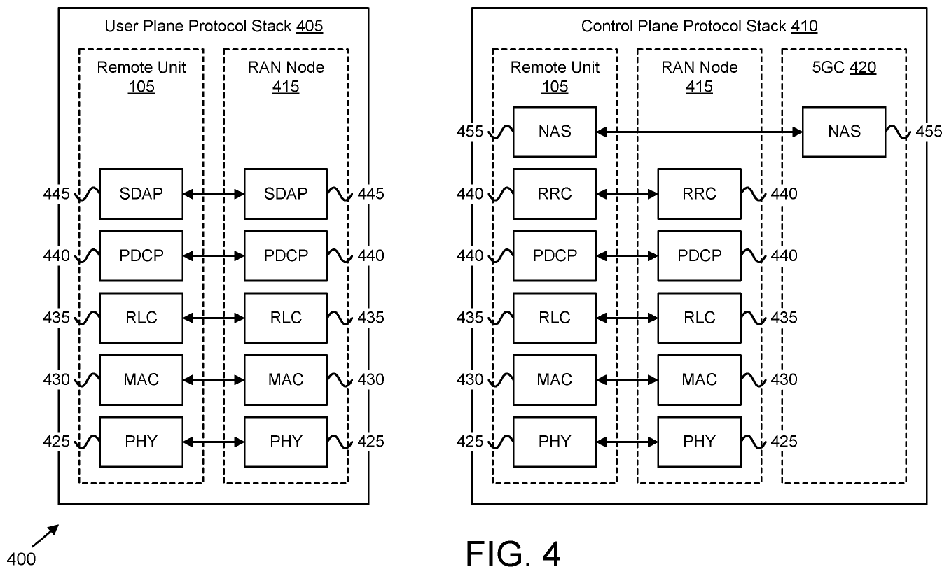

FIG. 4 depicts a protocol stack 400, according to embodiments of the disclosure. While FIG. 4 shows a remote unit 105 (i.e., a UE, such as the SL-Relay-UE (UE2) 203, a RAN node 415 (i.e., an embodiment of the base unit 121) and the 4G core (“5GC”) 420 (i.e., an embodiment of the mobile core network 140), these are representative of a set of UEs interacting with a RAN node and a NF (e.g., AMF) in a core network. As depicted, the protocol stack 400 comprises a User Plane protocol stack 405 and a Control Plane protocol stack 410. The User Plane protocol stack 405 includes a physical (“PHY”) layer 415, a Medium Access Control (“MAC”) sublayer 420, a Radio Link Control (“RLC”) sublayer 425, a Packet Data Convergence Protocol (“PDCP”) sublayer 430, and Service Data Adaptation Protocol (“SDAP”) layer 435. The Control Plane protocol stack 410 also includes a physical layer 415, a MAC sublayer 420, a RLC sublayer 425, and a PDCP sublayer 430. The Control Place protocol stack 410 also includes a Radio Resource Control (“RRC”) layer and a Non-Access Stratum (“NAS”) layer 445.

The AS protocol stack for the Control Plane protocol stack 410 consists of at least RRC, PDCP, RLC and MAC sublayers, and the physical layer. The AS protocol stack for the User Plane protocol stack 405 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 440 and the NAS layer 445 for the control plane and includes, e.g., an Internet Protocol (“IP”) layer or PDU Layer (note depicted) for the user plane. L1 and L2 are referred to as “lower layers” such as Physical Uplink Control Channel (“PUCCH”) and/or Physical Uplink Shared Channel (“PUSCH”) or MAC Control Element (“CE”), while L3 and above (e.g., transport layer, application layer) are referred to as “higher layers” or “upper layers” such as RRC.

The physical layer 415 offers transport channels to the MAC sublayer 420. The MAC sublayer 420 offers logical channels to the RLC sublayer 425. The RLC sublayer 425 offers RLC channels to the PDCP sublayer 430. The PDCP sublayer 430 offers radio bearers to the SDAP sublayer 435 and/or RRC layer 440. The SDAP sublayer 435 offers QoS flows to the mobile core network 140 (e.g., 4GC). The RRC layer 440 provides for the addition, modification, and release of Carrier Aggregation and/or Dual Connectivity. The RRC layer 440 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

The SL Relay UE(s) relaying communication between a UE and the network may implement the PC5 protocol stack 250 on the SL interface (e.g., Interface-1) and implement the NR protocol stack 400 on the Uu interface (e.g., Interface-2).

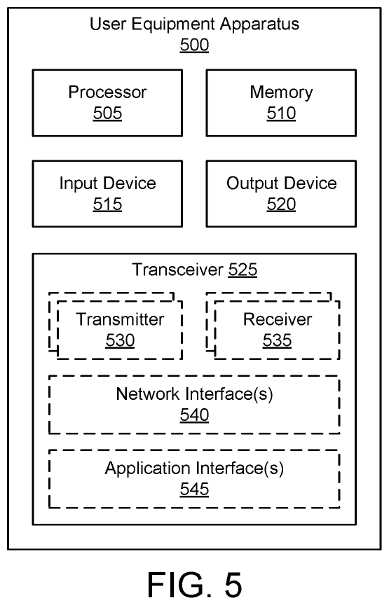

FIG. 5 depicts a user equipment apparatus 500 that may be used for relay advertisement for sidelink operation, according to embodiments of the disclosure. In various embodiments, the user equipment apparatus 500 is used to implement one or more of the solutions described above. The user equipment apparatus 500 may be one embodiment of the remote unit 105, the Tx-Remote-UE 201, the SL-Relay-UE 203 and/or the Rx-Remote-UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panels supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above described UE behaviors. In certain embodiments, the processor 505 may include an application processor (also known as “main processor”) which manages application-domain and operating system (“OS”) functions and a baseband processor (also known as “baseband radio processor”) which manages radio functions.

In various embodiments, the user equipment apparatus 500 operates as a Tx Remote UE. In such embodiments, the transceiver 525 may receive a relay advertisement from a SL Relay UE supporting sidelink operation, where the relay advertisement contains at least one relay attribute. The processor 505 determines that relay via the SL Relay UE is needed using the at least one relay attribute. The transceiver 525 sends a relay connection request to the SL Relay UE and receives a relay connection confirmation from the SL Relay UE. Via the transceiver 525, the processor 505 performs sidelink communication with a Rx Remote UE via the SL Relay UE.

In some embodiments, the at least one relay attribute comprises one or more of: HARQ Feedback support, support for Blind Retransmissions, supported PC5 QoS Identifiers (“PQIs”), supported cast types, supported service types, support for distance based sidelink HARQ feedback based communication, Minimum Communication Range (“MCR”) support capability, location availability, and Cell identity of a serving cell.

In some embodiments, the processor 505 further determines that relay via the SL Relay UE is needed based on one or more of: a radio condition of an interface between the apparatus and the SL Relay UE, a radio condition between the SL Relay UE and the Rx Remote UE, and geographical distance between the apparatus 500 and the SL Relay UE.

In some embodiments, the processor 505 searches for a candidate SL Relay UE in response to a detecting a trigger condition. In such embodiments, the trigger condition may be one or more of: reaching a predetermined number of unsuccessful attempts to communicate directly with the Rx Remote UE; determining that a conditions of a direct link to the Rx Remote UE are unsatisfactory; and/or not having access to the location of the apparatus or in response to reaching a predetermined battery state.

In some embodiments, the processor 505 searches for a candidate SL Relay UE during groupcast sidelink communication in response to determining that a threshold number of HARQ feedback acknowledgements are not received, e.g., when a threshold number of ACK responses (for HF Option 2) are missing, when a threshold number of NACK responses (for HF Option 1 or HF Option 2) are received, and/or when a threshold sum of missing ACK and NACK responses (for HF Option 2) is reached.

In some embodiments, the processor 505 detects a trigger to search for a candidate SL Relay UE while a first transmission to the Rx Remote UE is ongoing. In such embodiments, the processor 505 may terminate the first transmission in response to detecting the trigger. In certain embodiments, performing sidelink communication with a Rx Remote UE via the SL Relay UE comprises transmitting a last data packet (e.g., TB) that was unsuccessfully transmitted to the Rx Remote UE.

In some embodiments, the processor 505 sends transmissions directly to the Rx Remote UE while performing sidelink communication with a Rx Remote UE via the SL Relay UE. In such embodiments, the processor 505 may determine to stop performing sidelink communication with a Rx Remote UE via the SL Relay UE in response to reaching a threshold number of successful attempts to communicate directly with the Rx Remote UE.

In some embodiments, the processor 505 measures a radio quality of a direct link to the Rx Remote UE while performing sidelink communication with the Rx Remote UE via the SL Relay UE. In such embodiments, the processor 505 may determine to stop performing sidelink communication with a Rx Remote UE via the SL Relay UE in response to the radio quality of the direct link to the Rx Remote UE exceeding a threshold value.

In various embodiments, the user equipment apparatus 500 operates as a SL Relay UE. In such embodiments, the transceiver 525 may transmit a relay advertisement from a SL Relay UE supporting sidelink operation and receives a relay connection request from a Tx Remote UE, where the relay advertisement contains at least one relay attribute and where the Tx Remote UE selects the SL Relay UE using the at least one relay attribute. Via the transceiver 525, the processor 505 transmits a relay connection confirmation to the Tx Remote UE and relays sidelink communication between the Tx Remote UE and a Rx Remote UE.

In some embodiments, the at least one relay attribute comprises one or more of: HARQ Feedback support, support for Blind Retransmissions, supported PQIs, supported cast types, and supported service types. In some embodiments, the at least one relay attribute comprises one or more of: support for distance based sidelink HARQ feedback based communication, Minimum Communication Range support capability, location availability, and Cell identity of a serving cell.

Note that in the above descriptions, the Rx Remote UE may instead be a RAN node or other network entity, whereby the SL Relay UE communicates with the Tx Remote UE using sidelink and relays communication between the Tx Remote UE and the, e.g., RAN node.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to relay advertisement for sidelink operation. For example, the memory 510 may store various parameters, panel/beam configurations, resource assignments, policies, and the like as described above. In certain embodiments, the memory 510 also stores program code and related data, such as an operating system or other controller algorithms operating on the apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

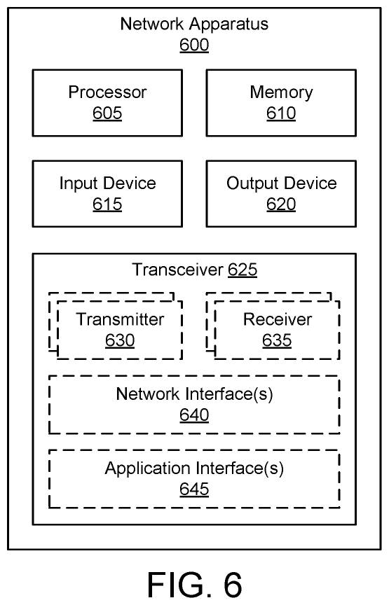

FIG. 6 depicts a network apparatus 600 that may be used for relay advertisement for sidelink operation, according to embodiments of the disclosure. In one embodiment, network apparatus 600 may be one implementation of a RAN node, such as the base unit 121 and/or the RAN node 210, as described above. Furthermore, the base network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the network apparatus 600 is a RAN node (e.g., gNB) that communicates with one or more UEs, as described herein. In such embodiments, the processor 605 controls the network apparatus 600 to perform the above described RAN behaviors. When operating as a RAN node, the processor 605 may include an application processor (also known as “main processor”) which manages application-domain and operating system (“OS”) functions and a baseband processor (also known as “baseband radio processor”) which manages radio functions.

In various embodiments, the processor 605 controls the transceiver 625 to communicate with a UE via the SL Relay UE. In one embodiment, the SL Relay UE communicates with a Tx Remote UE using sidelink and relays communication between the Tx Remote UE and the apparatus 600. In another embodiment, the SL Relay UE communicates with a Rx Remote UE using sidelink and relays communication between the Rx Remote UE and the apparatus 600.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to relay advertisement for sidelink operation. For example, the memory 610 may store parameters, configurations, resource assignments, policies, and the like, as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the PLMN and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

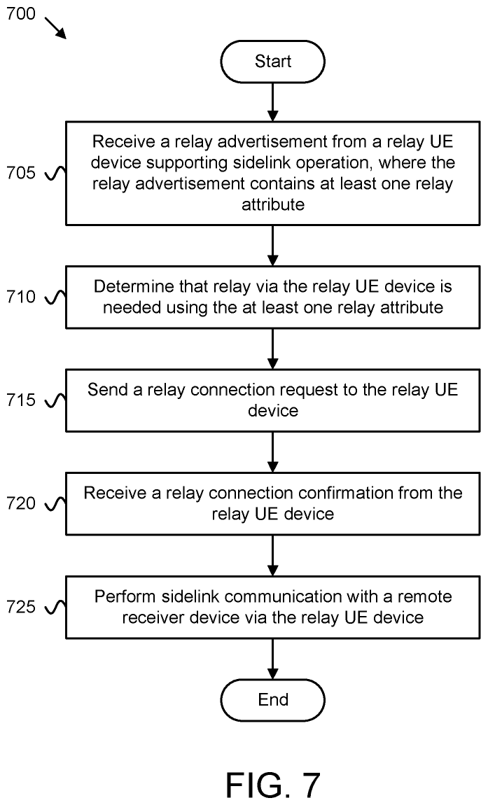

FIG. 7 depicts one embodiment of a method 700 for relay advertisement for sidelink operation, according to embodiments of the disclosure. In various embodiments, the method 700 is performed by a user equipment device in a mobile communication network, such as the remote unit 105, the Tx-Remote-UE (i.e., UE1) 201, the Rx-Remote-UE (i.e., UE3) 205, and/or the user equipment apparatus 500, described above. In some embodiments, the method 700 is performed by a processor, such as a microcontroller, a microprocessor, a CPU, a GPU, an auxiliary processing unit, a FPGA, or the like.

The method 700 begins and receives 705 receiving a relay advertisement from a SL Relay UE supporting sidelink operation, where the relay advertisement contains at least one relay attribute. The method 700 includes determining 710 that relay via the SL Relay UE is needed using the at least one relay attribute. The method 700 includes sending 715 a relay connection request to the SL Relay UE and receiving 720 a relay connection confirmation from the SL Relay UE. The method 700 includes performing 725 sidelink communication with a Rx remote UE via the SL Relay UE. The method 700 ends.

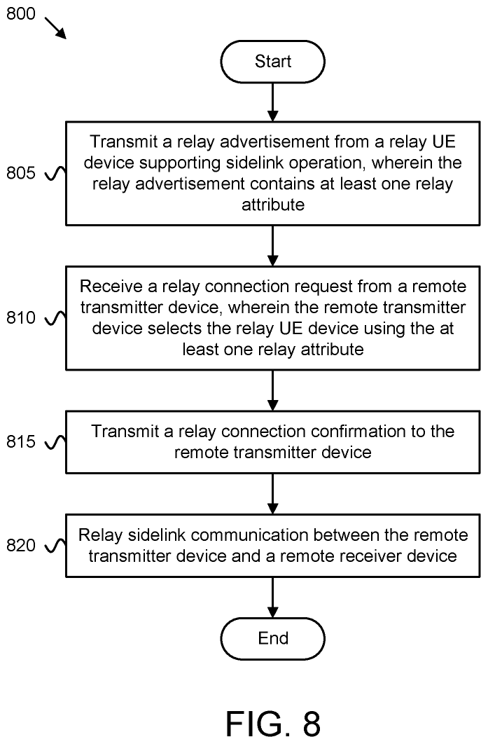

FIG. 8 depicts one embodiment of a method 800 for relay advertisement for sidelink operation, according to embodiments of the disclosure. In various embodiments, the method 800 is performed by a sidelink SL Relay UE in a mobile communication network, such as the remote unit 105, the SL-Relay-UE (i.e., UE2) 203, and/or the user equipment apparatus 500, described above. In some embodiments, the method 800 is performed by a processor, such as a microcontroller, a microprocessor, a CPU, a GPU, an auxiliary processing unit, a FPGA, or the like.

The method 800 begins and transmits 805 a relay advertisement from a SL Relay UE supporting sidelink operation, where the relay advertisement contains at least one relay attribute. The method 800 includes receiving 810 a relay connection request from a remote transmitter device, where the remote transmitter device selects the SL Relay UE using the at least one relay attribute. The method 800 includes transmitting 815 a relay connection confirmation to the remote transmitter device. The method 800 includes relaying 820 sidelink communication between the remote transmitter device and a remote receiver device. The method 800 ends.

Disclosed herein is a first apparatus relay advertisement for sidelink operation, according to embodiments of the disclosure. The first apparatus may be implemented by a transmitting remote UE device in a mobile communication network, such as the remote unit 105, the Tx-Remote-UE (i.e., UE1) 201, and/or the user equipment apparatus 500, described above. The first apparatus includes a processor and a transceiver that receives a relay advertisement from a SL Relay UE supporting sidelink operation, where the relay advertisement contains at least one relay attribute. The processor determines that relay via the SL Relay UE is needed using the at least one relay attribute. The transceiver sends a relay connection request to the SL Relay UE and receives a relay connection confirmation from the SL Relay UE. Via the transceiver, the processor performs sidelink communication with a remote receiver device via the SL Relay UE.

In some embodiments, the at least one relay attribute comprises one or more of: HARQ Feedback support, support for Blind Retransmissions, supported PC5 QoS Identifiers (“PQIs”), supported cast types, supported service types, support for distance based sidelink HARQ feedback based communication, Minimum Communication Range support capability, location availability, and Cell identity of a serving cell.

In some embodiments, the processor further determines that relay via the SL Relay UE is needed based on one or more of: a radio condition of an interface between the apparatus and the SL Relay UE, a radio condition between the SL Relay UE and the remote receiver device, and geographical distance between the apparatus and the SL Relay UE.

In some embodiments, the processor searches for a candidate SL Relay UE in response to a detecting a trigger condition. In such embodiments, the trigger condition may be one or more of: reaching a predetermined number of unsuccessful attempts to communicate directly with the remote receiver device; determining that a conditions of a direct link to the remote receiver device are unsatisfactory; and/or not having access to the location of the apparatus or in response to reaching a predetermined battery state.

In some embodiments, the processor searches for a candidate SL Relay UE during groupcast sidelink communication in response to determining that a threshold number of HARQ feedback acknowledgements are not received, e.g., when a threshold number of ACK responses (for HF Option 2) are missing, when a threshold number of NACK responses (for HF Option 1 or HF Option 2) are received, and/or when a threshold sum of missing ACK and NACK responses (for HF option 2) is reached.

In some embodiments, the processor detects a trigger to search for a candidate SL Relay UE while a first transmission to the remote receiver device is ongoing. In such embodiments, the processor may terminate the first transmission in response to detecting the trigger. In certain embodiments, performing sidelink communication with a remote receiver device via the SL Relay UE comprises transmitting a last data packet (e.g., TB) that was unsuccessfully transmitted to the remote receiver device.

In some embodiments, the processor sends transmissions directly to the remote receiver device while performing sidelink communication with a remote receiver device via the SL Relay UE. In such embodiments, the processor may determine to stop performing sidelink communication with a remote receiver device via the SL Relay UE in response to reaching a threshold number of successful attempts to communicate directly with the remote receiver device.

In some embodiments, the processor measures a radio quality of a direct link to the remote receiver device while performing sidelink communication with a remote receiver device via the SL Relay UE. In such embodiments, the processor may determine to stop performing sidelink communication with a remote receiver device via the SL Relay UE in response to the radio quality of the direct link to the remote receiver device exceeding a threshold value.

Disclosed herein is a first method for relay advertisement for sidelink operation, according to embodiments of the disclosure. The first method may be performed by a transmitting remote UE device in a mobile communication network, such as the remote unit 105, the Tx-Remote-UE (i.e., UE1) 201, and/or the user equipment apparatus 500, described above. The first method includes receiving a relay advertisement from a SL Relay UE supporting sidelink operation, where the relay advertisement contains at least one relay attribute. The first method includes determining that relay via the SL Relay UE is needed using the at least one relay attribute and sending a relay connection request to the SL Relay UE. The first method includes receiving a relay connection confirmation from the SL Relay UE and performing sidelink communication with a remote receiver device via the SL Relay UE.

In some embodiments, the at least one relay attribute comprises one or more of: HARQ Feedback support, support for Blind Retransmissions, supported PC5 QoS Identifiers (“PQIs”), supported cast types, supported service types, support for distance based sidelink HARQ feedback based communication, Minimum Communication Range support capability, location availability, and Cell identity of a serving cell.

In some embodiments, the first method includes determining that relay via the SL Relay UE is needed based on one or more of: a radio condition of an interface between the transmitting remote UE device and the SL Relay UE, a radio condition between the SL Relay UE and the remote receiver device, and geographical distance between the transmitting remote UE device and the SL Relay UE.

In some embodiments, the first method includes searching for a candidate SL Relay UE in response to a detecting a trigger condition. In such embodiments, the trigger condition may be one or more of: reaching a predetermined number of unsuccessful attempts to communicate directly with the remote receiver device; determining that a conditions of a direct link to the remote receiver device are unsatisfactory; and/or not having access to the location of the transmitting remote UE device or in response to reaching a predetermined battery state.

In some embodiments, the first method includes searching for a candidate SL Relay UE during groupcast sidelink communication in response to determining that a threshold number of HARQ feedback acknowledgements are not received, e.g., when a threshold number of ACK responses (for HF Option 2) are missing, when a threshold number of NACK responses (for HF Option 1 or HF Option 2) are received, and/or when a threshold sum of missing ACK and NACK responses (for HF option 2) is reached.

In some embodiments, the first method includes detecting the trigger to search for a candidate SL Relay UE while a first transmission to the remote receiver device is ongoing. In such embodiments, the first method may include terminating the first transmission in response to detecting the trigger. In certain embodiments, performing sidelink communication with a remote receiver device via the SL Relay UE comprises transmitting a last data packet (e.g., TB) that was unsuccessfully transmitted to the remote receiver device.

In some embodiments, the first method includes sending transmissions directly to the remote receiver device while performing sidelink communication with a remote receiver device via the SL Relay UE. In such embodiments, the first method includes determining to stop performing sidelink communication with a remote receiver device via the SL Relay UE in response to reaching a threshold number of successful attempts to communicate directly with the remote receiver device.

In some embodiments, the first method includes measuring a radio quality of a direct link to the remote receiver device while performing sidelink communication with a remote receiver device via the SL Relay UE. In such embodiments, the first method includes determining to stop performing sidelink communication with a remote receiver device via the SL Relay UE in response to the radio quality of the direct link to the remote receiver device exceeding a threshold value.

Disclosed herein is a second apparatus for relay advertisement for sidelink operation, according to embodiments of the disclosure. The second apparatus may be implemented by a sidelink SL Relay UE in a mobile communication network, such as the remote unit 105, the SL-Relay-UE (i.e., UE2) 203, and/or the user equipment apparatus 500, described above. The second apparatus includes a processor and a transceiver that transmits a relay advertisement from a SL Relay UE supporting sidelink operation and receives a relay connection request from a remote transmitter device, where the relay advertisement contains at least one relay attribute and where the remote transmitter device selects the SL Relay UE using the at least one relay attribute. The transceiver transmits a relay connection confirmation to the remote transmitter device and the processor relays sidelink communication between the remote transmitter device and a remote receiver device.

In some embodiments, the at least one relay attribute comprises one or more of: HARQ Feedback support, support for Blind Retransmissions, supported PQIs, supported cast types, and supported service types. In some embodiments, the at least one relay attribute comprises one or more of: support for distance based sidelink HARQ feedback based communication, Minimum Communication Range support capability, location availability, and Cell identity of a serving cell.

Disclosed herein is a second method for relay advertisement for sidelink operation, according to embodiments of the disclosure. The second method may be performed by a sidelink SL Relay UE in a mobile communication network, such as the remote unit 105, the SL-Relay-UE (i.e., UE2) 203, and/or the user equipment apparatus 500, described above. The second method includes transmitting a relay advertisement from a SL Relay UE supporting sidelink operation and receiving a relay connection request from a remote transmitter device, where the relay advertisement contains at least one relay attribute and where the remote transmitter device selects the SL Relay UE using the at least one relay attribute. The second method includes transmitting a relay connection confirmation to the remote transmitter device and relaying sidelink communication between the remote transmitter device and a remote receiver device.

In some embodiments, the at least one relay attribute comprises one or more of: HARQ Feedback support, support for Blind Retransmissions, supported PQIs, supported cast types, and supported service types. In some embodiments, the at least one relay attribute comprises one or more of: support for distance based sidelink HARQ feedback based communication, Minimum Communication Range support capability, location availability, and Cell identity of a serving cell.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A User Equipment (“UE”) apparatus comprising:
a memory; and
a processor coupled to the memory, the processor is configured to cause the apparatus to:
receive a relay advertisement from a SL Relay UE supporting sidelink operation, wherein the relay advertisement contains at least one relay attribute;
determine that relay via the SL Relay UE is needed using the at least one relay attribute;
send a relay connection request to the SL Relay UE;
receive a relay connection confirmation from the SL Relay UE; and
perform sidelink communication with a remote receiver device via the SL Relay UE.

17. The apparatus of claim 16, wherein the at least one relay attribute comprises one or more of:
a HARQ Feedback support,
a support for Blind Retransmissions,
supported PC5 QoS Identifiers (“PQIs”),
supported cast types,
supported service types,
or a combination thereof.

18. The apparatus of claim 16, wherein the at least one relay attribute comprises one or more of:
a support for distance based sidelink HARQ feedback based communication,
a Minimum Communication Range support capability,
a location availability,
a Cell identity of a serving cell,
or a combination thereof.

19. The apparatus of claim 16, wherein the processor further determines that relay via the SL Relay UE is needed based on one or more of:
a radio condition of an interface between the apparatus and the SL Relay UE,
a radio condition between the SL Relay UE and the remote receiver device,
a geographical distance between the apparatus and the SL Relay UE,
or a combination thereof.

20. The apparatus of claim 16, wherein the processor is configured to cause the apparatus to search for a candidate SL Relay UE in response to reaching a predetermined number of unsuccessful attempts to communicate directly with the remote receiver device or in response to the apparatus determining that a conditions of a direct link to the remote receiver device are unsatisfactory.

21. The apparatus of claim 16, wherein the processor is configured to cause the apparatus to search for a candidate SL Relay UE during groupcast sidelink communication in response to the apparatus determining that a threshold number of HARQ feedback acknowledgements are not received.

22. The apparatus of claim 16, wherein the processor is configured to cause the apparatus to search for a candidate SL Relay UE in response to not having access to the location of the apparatus or in response to reaching a predetermined battery state.

23. The apparatus of claim 16, wherein the processor is configured to cause the apparatus to:
detect a trigger to search for a candidate SL Relay UE while a first transmission to the remote receiver device is ongoing, and
terminate the first transmission in response to detecting the trigger.

24. The apparatus of claim 23, wherein to perform sidelink communication with a remote receiver device via the SL Relay UE, the processor is configured to cause the apparatus to transmit a last data packet that was unsuccessfully transmitted to the remote receiver device.

25. The apparatus of claim 16, wherein the processor is configured to cause the apparatus to:
send transmissions directly to the remote receiver device while performing sidelink communication with a remote receiver device via the SL Relay UE, and
determine to stop performing sidelink communication with a remote receiver device via the SL Relay UE in response to reaching a threshold number of successful attempts to communicate directly with the remote receiver device.

26. The apparatus of claim 16, wherein the processor is configured to cause the apparatus to:
measure a radio quality of a direct link to the remote receiver device while performing sidelink communication with a remote receiver device via the SL Relay UE, and
determine to stop performing sidelink communication with a remote receiver device via the SL Relay UE in response to the radio quality of the direct link to the remote receiver device exceeding a threshold value.

27. A method of a User Equipment (“UE”), the method comprising:
receiving a relay advertisement from a SL Relay UE supporting sidelink operation, wherein the relay advertisement contains at least one relay attribute;
determining that relay via the SL Relay UE is needed using the at least one relay attribute;
sending a relay connection request to the SL Relay UE;
receiving a relay connection confirmation from the SL Relay UE; and
performing sidelink communication with a remote receiver device via the SL Relay UE.

28. The method of claim 27, further comprising searching for a candidate SL Relay UE during groupcast sidelink communication in response to determining that a threshold number of HARQ feedback acknowledgements are not received.

29. The method of claim 27, further comprising searching for a candidate SL Relay UE in response to not having access to the location of the UE or in response to reaching a predetermined battery state.

30. The method of claim 27, further comprising:
detecting a trigger to search for a candidate SL Relay UE while a first transmission to the remote receiver device is ongoing; and
terminating the first transmission in response to detecting the trigger,
wherein performing sidelink communication with a remote receiver device via the SL Relay UE comprises transmitting a last data packet that was unsuccessfully transmitted to the remote receiver device.

31. The method of claim 27, further comprising:
sending transmissions directly to the remote receiver device while performing sidelink communication with a remote receiver device via the SL Relay UE; and
determining to stop performing sidelink communication with a remote receiver device via the SL Relay UE in response to reaching a threshold number of successful attempts to communicate directly with the remote receiver device.

32. The method of claim 27, further comprising:
measuring a radio quality of a direct link to the remote receiver device while performing sidelink communication with a remote receiver device via the SL Relay UE, and
determining to stop performing sidelink communication with a remote receiver device via the SL Relay UE in response to the radio quality of the direct link to the remote receiver device exceeding a threshold value.

33. A relay User Equipment (“UE”) apparatus comprising:
a memory; and
a processor coupled to the memory, the processor configured to cause the apparatus to:
transmit a relay advertisement supporting sidelink operation, wherein the relay advertisement contains at least one relay attribute for selecting a sidelink relay;
receive a relay connection request from a remote transmitter device;
transmit a relay connection confirmation to the remote transmitter device; and
relay sidelink communication between the remote transmitter device and a remote receiver device.

34. The apparatus of claim 33, wherein the at least one relay attribute comprises one or more of:
a HARQ Feedback support,
a support for Blind Retransmissions,
supported PC5 QoS Identifiers (“PQIs”),
supported cast types,
supported service types,
or a combination thereof.

35. The apparatus of claim 33, wherein the at least one relay attribute comprises one or more of:
a support for distance based sidelink HARQ feedback based communication,
a Minimum Communication Range support capability,
a location availability,
a Cell identity of a serving cell,
or a combination thereof.
